(19) United States
(12) Patent Application Publication
(10) Pub. No.: US 2007/0080642 A1
(43) Pub. Date: Apr. 12, 2007

(54) Gas discharge display device and fabricating method thereof

(76) Inventor: Seung-Hyun Son, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/542,914

(22) Filed: Oct. 3, 2006

(30) Foreign Application Priority Data
Oct. 12, 2005 (KR) 10-2005-0096233

(51) Int. Cl. H01J 9/24; H01J 17/49

(52) U.S. Cl. 313/586; 313/582; 445/24

(57) ABSTRACT

Provided are a gas discharge display device capable of implementing high resolution and a method of fabricating the same. The gas discharge display device includes a substrate. A silicon member is attached to the substrate. The silicon member has a groove formed on at least a portion of an inner surface of the silicon member and forms a discharge space in cooperation with the substrate. A discharge electrode is disposed on the substrate. Discharge gas is contained in the discharge space.

### CROSS-REFERENCE TO RELATED PATENT APPLICATION

This application claims the benefit of Korean Patent Application No. 10-2005-0096233, filed on Oct. 12, 2005, in the Korean Intellectual Property Office, the disclosure of which is incorporated herein in its entirety by reference.

### BACKGROUND OF THE INVENTION

1. Field of the Invention

The present embodiments relate to a gas discharge display device, and more particularly, to a gas discharge display device capable of implementing high resolution while having a simple and efficient structure and a method of fabricating the same.

2. Description of the Related Art

The PDP is a flat panel device in which a discharge gas is hermetically filled between two substrates on which a plurality of electrodes are formed. When a discharge voltage is applied across the electrodes, ultraviolet rays are generated to excite a phosphor formed in a predetermined pattern. The excited phosphor emits visible rays, thereby creating an image.

FIG. 1 is an exploded perspective view of a conventional AC PDP.

Referring to FIG. 1, a PDP 10 includes a transparent front substrate 11 and a rear substrate 12.

Stripe-shaped sustain electrodes 13a and bus electrodes 13c are formed on the front substrate 11, and a dielectric layer 14 and a protection layer 15 are formed on the resulting structure.

Stripe-shaped address electrodes 13b, a dielectric layer 16, barrier ribs 17, and a phosphor layer are formed on the rear substrate 12.

The sustain electrodes 13a are perpendicular to the address electrodes 13b, and a discharge space is defined by the barrier ribs 17 to form a discharge cell.

However, the conventional PDP is complex in structure because it requires many processes for forming the electrodes and the front and rear substrates are attached and sealed using frit. Accordingly, the conventional PDP is complex in fabrication process and is large in the size of the discharge cell. Therefore, it is difficult to implement high resolution using the convention PDP.

Accordingly, there is required a new gas discharge display device capable of implementing high resolution while being simple and efficient in structure and convenient in fabrication process.

### SUMMARY OF THE INVENTION

The present embodiments provide a gas discharge display device capable of implementing high resolution while having a simple and efficient structure and a method of fabricating the same.

According to an aspect of the present embodiments, there is provided a gas discharge display device including: a substrate; a silicon member attached to the substrate, the silicon member having a groove formed on at least a part of an inner surface of the silicon member and forming a discharge space in cooperation with the substrate; a discharge electrode disposed on the substrate; and discharge gas disposed in the discharge space.

The substrate may include glass.

The silicon member may be attached to the substrate by anodic bonding.

The silicon member may include monocrystalline silicon.

The silicon member may be formed using an SOI (silicon on insulator) wafer.

The SOI wafer may include at least two silicon layers and a silicon oxide (SiO₂) layer formed between the silicon layers.

The groove may be formed by an etching process using KOH (potassium hydroxide).

The groove may be formed by a DRIE (deep reactive ion etching) process.

The discharge electrode may include an ITO (indium tin oxide).

The silicon member and the discharge electrode may function as a cathode electrode and the other may function as an anode electrode.

The discharge gas may include neon (Ne).

The discharge gas may include xenon (Xe).

When the discharge electrode is formed to such a length to contact another portion of the inner surface of the silicon member where the groove is not formed, the gas discharge display device may further include an insulating layer formed on at least a part of the another portion to electrically insulate the discharge electrode from the silicon member.

The insulating layer may include a silicon oxide (SiO₂).

The gas discharge display device may further include a phosphor layer disposed in the discharge space.

The phosphor layer may include one selected from the group consisting of a photoluminescent phosphor, a cathodoluminescent phosphor, and quantum dot.

According to another aspect of the present embodiments, there is provided a method of fabricating a gas discharge display device, the method including: forming a discharge electrode on an inner surface of a substrate; forming a groove at an inner surface of a silicon wafer to form a silicon member; and joining the substrate and the silicon member by an anodic bonding process to form a discharge space.

The silicon wafer may be an SOI wafer.

The groove may be formed by an etching process using KOH (potassium hydroxide).

The groove may be formed by a DRIE process.

The anodic bonding process may be performed in a place containing discharge gas of a given pressure.

The anodic bonding process may be performed in an atmospheric environment.

The method may further include, after the anodic bonding process, discharging air of the discharge space and then hermetically filling the discharge space with discharge gas.

The method may further include forming a phosphor layer in the discharge space.

The method may further include, when the discharge electrode is formed to such a length to contact another portion of an inner surface of the silicon member where the groove is not formed, forming an insulating layer on at least a part of the another portion to electrically insulate the discharge electrode from the silicon member.

The insulating layer may include silicon oxide (SiO₂).

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional AC PDP;

FIG. 2 is a cutaway perspective view of a gas discharge display device according to an embodiment of the present embodiments;

FIG. 3 is a sectional view taken along line III-III of FIG. 2;

FIG. 4 is a right side view of the gas discharge display device illustrated in FIG. 2;

FIGS. 5 through 7 are sectional views illustrating a process of forming a silicon member according to an embodiment of the present embodiments;

FIG. 8 is a cutaway perspective view of a gas discharge display device according to another embodiment of the present embodiments;

FIG. 9 is a sectional view taken along line IX-IX of FIG. 8; and

FIGS. 10 through 12 are sectional views illustrating a process of forming a silicon member according to another embodiment.

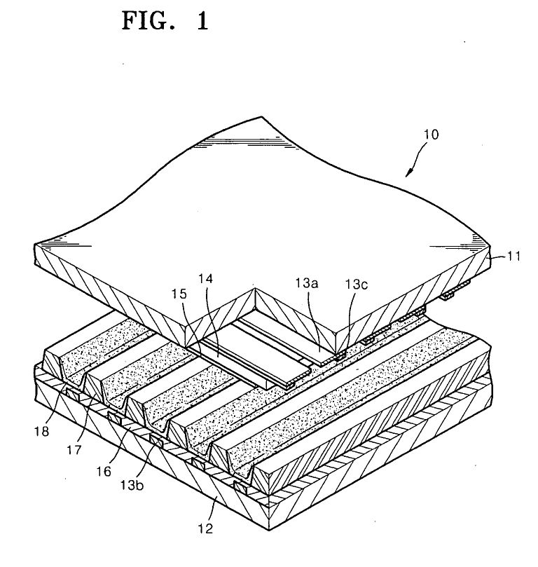

### DETAILED DESCRIPTION OF THE INVENTION

The present embodiments will now be described more fully with reference to the accompanying drawings, in which exemplary embodiments are shown.

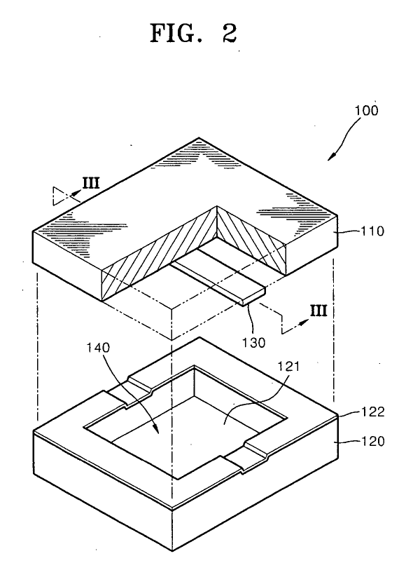

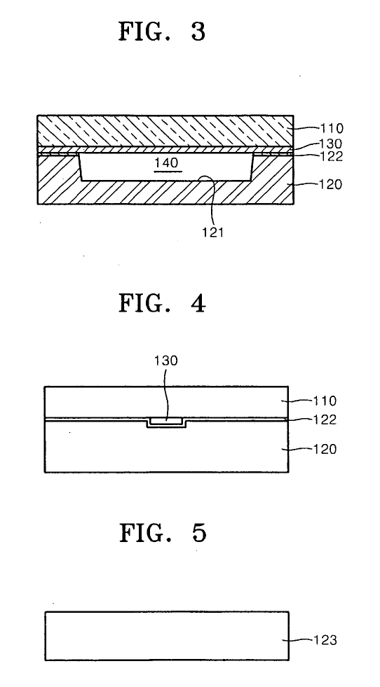

FIG. 2 is a cutaway perspective view of a gas discharge display device according to an embodiment, FIG. 3 is a sectional view taken along line III-III of FIG. 2, and FIG. 4 is a right side view of the gas discharge display device illustrated in FIG. 2.

Referring to FIGS. 2 through 4, a gas discharge display device 100 includes a substrate 110, a silicon member 120, and a discharge electrode 130.

The substrate 110 is formed of transparent glass, and thus visible rays can penetrate the substrate 110.

The silicon member 120 is formed of monocrystalline silicon, and thus a driving circuit can be directly disposed on the silicon member 120.

Although the silicon member 120 is formed using a single silicon wafer, the present embodiments are not limited to this structure. For example, the silicon member 120 may be formed using silicon on insulator (SOI).

The silicon member 120 has a shape, for example, of a cuboid with a groove 121 formed on its inner surface.

The groove 121 serves to form a discharge space 140 in cooperation with the substrate 110 when the gas discharge display device 100 is completely assembled. An insulating layer 122 is formed on a portion of the inner surface of the silicon member 120 where the groove 121 is not formed.

The insulating layer 122 is formed for electrical insulation between the silicon member 120 and the discharge electrode 130, and may be formed using a material such as a silicon oxide (SiO₂) and a lead oxide (PbO).

Although the insulating layer 122 is formed on all the portion of the inner surface of the silicon member 120 where the groove 121 is not formed, the present embodiments are not limited to this structure. That is, the insulating layer 122 may be formed to a minimum area necessary for the electrical insulation between the silicon member 120 and the discharge electrode 130. Also, when the discharge electrode 130 is formed only on the center of the substrate 110 that does not contact the silicon member 120, the insulation layer 122 may not need to be formed.

The discharge electrode 130 is disposed on a lower surface of the substrate 110, and is formed in a stripe pattern.

Although the discharge electrode 130 is formed in the stripe pattern, the present embodiments are not limited to this structure. That is, the discharge electrode 130 may be formed on the center of the substrate 110 so that it does not contact the silicon member 120. In this case, the discharge electrode 130 may be formed in various shapes, such as, for example, a rectangular shape or a circular shape. In this case, a connection hole for connecting the discharge electrode 130 to an external power source may be formed in the substrate 110.

The discharge electrode 130 may be a transparent electrode formed using an indium tin oxide (ITO).

Although the discharge electrode 130 is formed using an ITO electrode, the present embodiments are not limited to this structure. That is, the discharge electrode 130 may be formed using other materials, such as silver (Ag), copper (Cu), and aluminum (Al). In order to increase the transmittance of visible light, the discharge electrode 130 is preferably formed of an ITO.

As described above, after the discharge electrode 130 is disposed on the substrate 110 and the groove 121 and the insulating layer 122 are formed on the silicon member 120, the silicon member 120 is attached to the substrate 110, thereby forming the gas discharge display device 100 with the discharge space 140 formed therein.

The silicon member 120 may be attached by anodic bonding to the substrate 110. In the anodic bonding process, the discharge space 140 is hermetically filled with discharge gas formed of at least one selected from the group consisting of nitrogen (N₂), heavy hydrogen (D₂), carbon dioxide (CO₂), carbon monoxide (CO), hydrogen (H2) air of atmospheric pressure, noble or inert gases, neon (Ne), xenon (Xe), helium (He), argon (Ar), Krypton (Kr) and a mixture thereof.

Although no phosphor layer is formed in the discharge space 140 of the gas discharge display device 100, the present embodiments are not limited to this structure. That is, the gas discharge display device 100 may further include a phosphor layer for emitting visible light using ultraviolet rays generated by gas discharge.

A method of fabricating the gas discharge display device 100 will now be described.

First, a discharge electrode 130 is formed on an inner surface of a glass substrate 110 by a printing process.

Next, a process of forming the silicon member 120 will now be described in detail with reference to FIGS. 5 through 7.

FIGS. 5 through 7 are sectional views illustrating a process of forming the silicon member 120 according to an embodiment.

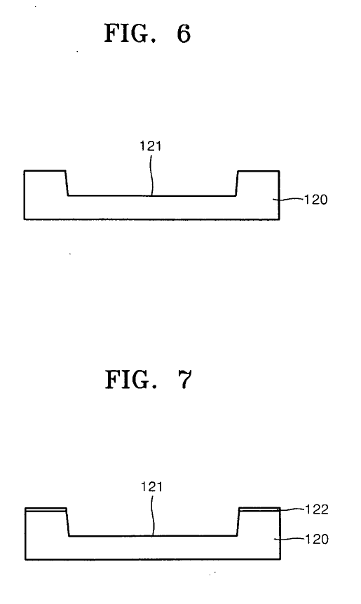

The silicon member 120 includes a groove 121. The groove 121 may be formed by wet etching or dry etching. In the present embodiment, the groove 121 is formed by wet etching. As illustrated in FIGS. 5 and 6, a silicon wafer 123 with a given size is etched using a potassium hydroxide (KOH) solution, thereby forming the silicon member 120 with the groove 121 formed therein.

Thereafter, as illustrated in FIG. 7, an insulating layer 122 is formed on a portion of an inner surface of the silicon where the groove 121 is not formed. The insulating layer 122 may be formed of a silicon oxide (SiO₂) by a printing process.

Thereafter, the silicon member 120 is attached to the substrate 110. The silicon member 120 is joined to the substrate 110 in a chamber containing discharge gas of a given pressure. At this point, the silicon member 120 is attached to the substrate 110 by anodic bonding.

In the anodic bonding process, after the silicon member 120 is brought into contact with the substrate 110, the silicon member 120 and the substrate 110 are joined together by chemical reaction. This chemical reaction may be generated by a high voltage applied at a high temperature of about 450° C.

When the silicon member 120 and the substrate 110 are joined together by anodic bonding, degradation or destruction of the insulating layer 122 can be prevented while maintaining the gas tightness of the discharge space 140. Accordingly, as illustrated in FIG. 4, the insulating state between the silicon member 120 and the discharge electrode 130 can be maintained even after the silicon member 120 and the substrate 110 are joined together.

In the present embodiment, the anodic bonding process for attaching the silicon member 120 to the substrate 110 is performed in a chamber containing discharge gas of a given pressure and thus the discharge gas is placed into the discharge space 140. However, the present embodiments are not limited to this. That is, the anodic bonding process may also be performed in a general atmospheric environment. In addition, a discharge hole may be formed in the substrate 110 after the anodic bonding process to discharge air of the discharge space 140, and then suitable discharge gas may be injected through the discharge hole into the discharge space 140.

An operation of the gas discharge display device 100 will now be described.

When a DC discharge voltage is applied from an external power source to the silicon member 120 and the discharge electrode 130, a current flows though the silicon member 120 functioning as a cathode electrode. The reason for this is that the discharge space 140 is much higher in resistance than the silicon member 120.

When a voltage is applied to the silicon member 120, electrons are emitted from the silicon member 120 into the discharge space 140. After generating gas discharge, the emitted electrons are absorbed by the discharge electrode 130 functioning as an anode electrode.

In this manner, when suitable gas discharge occurs between the silicon member 120 and the discharge electrode 130, the discharge gas is excited. At this point, the energy level of the excided discharge gas is lowered to emit visible light.

The emitted visible light is outputted through the substrate 110, thereby creating an image perceivable by users.

Although a DC discharge voltage is applied to the silicon member 120 and the discharge electrode 130, the present embodiments are not limited to this. That is, in order to perform the gas discharge, an AC voltage may be applied to the silicon member 120 and the discharge electrode 130.

As above, the gas discharge display device 100 is simple in structure and can be easily fabricated using a minute silicon process. Therefore, the gas discharge device 100 can be miniaturized and thus a minute discharge cell can be implemented. Accordingly, when the discharge cells are arranged in a tile fashion, it is possible to implement the gas discharge display device with high resolution.

In addition, since the silicon member 120 is formed using monocrystalline silicon, the driving circuit can be directly formed on the silicon member 120, thereby reducing the required space and cost.

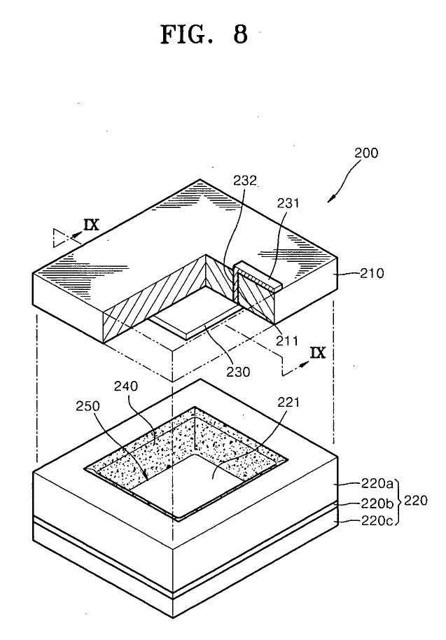

Hereinafter, another embodiment will be described in detail with reference to FIGS. 8 through 12.

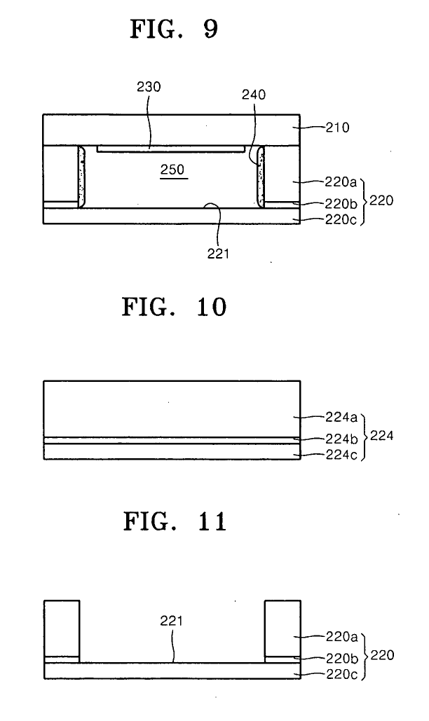

FIG. 8 is a cutaway perspective view of a gas discharge display device according to another embodiment, and FIG. 9 is a sectional view taken along line IX-IX of FIG. 8.

Referring to FIGS. 8 and 9, a gas discharge display device 200 includes a substrate 210, a silicon member 220, a discharge electrode 230, and a phosphor layer 240.

The substrate 210 can be formed of transparent glass, and thus visible rays can penetrate the substrate 210.

The silicon member 220 is formed of monocrystalline silicon, and thus a driving circuit can be directly disposed on the silicon member 220.

In the present embodiment, the silicon member 220 is formed using an SOI wafer. The SOI wafer includes two silicon layers and a silicon oxide layer formed therebetween. Accordingly, the silicon member 220 includes a first silicon layer 220a, a second silicon layer 220c, and a silicon oxide layer 220b formed between the first silicon layer 220a and the second silicon layer 220c.

In one embodiment, the silicon member 220 has the shape of a cuboid with a groove 221 formed on its inner surface.

The groove 221 serves to form a discharge space 250 in cooperation with the substrate 210 when the gas discharge display 200 is completely assembled.

The discharge electrode 230 is disposed on a lower surface of the substrate 210, and is formed in the shape of a quadrangle plate.

In order to apply a voltage to the discharge electrode 230, the discharge electrode 230 is electrically connected to an external power source. The discharge electrode 230 is electrically connected to a terminal electrode 231 connected to the external power source. This electrical connection is implemented by forming a connection hole 211 in the substrate 210 and then forming a connection electrode 232 in the connection hole 211.

The discharge electrode 230 may be a transparent electrode formed using an ITO.

The phosphor layer 240 is formed on the side surface of the discharge space 250.

The phosphor layer 240 may be formed using various phosphors. In the present embodiment, the phosphor layer 240 is formed of a photoluminescent phosphor.

The photoluminescent phosphor has an element that emits visible light when receiving ultraviolet rays. For example, a red phosphor layer emitting red visible light includes a phosphor such as Y(V,P)O₄:Eu, a green phosphor layer emitting green visible light includes a phosphor such as Zn₂SiO₄:Mn, and a blue phosphor layer emitting blue visible light includes a phosphor such as BAM:Eu.

Although the phosphor layer 240 in FIG. 8 is formed of a photoluminescent phosphor, the present embodiments are not limited to this structure. For example, the phosphor layer 240 may be formed using a cathodoluminescent phosphor or a quantum dot. That is, the phosphor layer 240 may be formed using one selected from the group consisting of a photoluminescent phosphor, a cathodoluminescent phosphor, and quantum dot. Also, the gas discharge display play 200 may not include the phosphor layer. In this case, the emitting operation is performed using only the visible light emitted by the discharge gas.

As described above, after the discharge electrode 230 is disposed on the substrate 110 and the groove 221 and the phosphor layer 240 are formed on the silicon member 220, the silicon member 220 is attached to the substrate 210, thereby forming the gas discharge display device 200 with the discharge space 250 formed therein.

The silicon member 220 may be attached by anodic bonding to the substrate 210. In the anodic bonding process, the discharge space 240 is hermetically filled with discharge gas formed at least one selected from the group consisting of nitrogen (N₂), heavy hydrogen (D₂), carbon dioxide (CO₂), carbon monoxide (CO), hydrogen (H2) air of atmospheric pressure, noble or inert gases, neon (Ne), xenon (Xe), helium (He), argon (Ar), Krypton (Kr) and a mixture thereof.

A method of fabricating the gas discharge display device 200 will now be described.

First, a discharge electrode 230 is formed on an inner surface of a glass substrate 210 by a printing process.

Next, a process of forming the silicon member 220 will now be described with reference to FIGS. 10 through 12.

FIGS. 10 through 12 are sectional views illustrating a process of forming the silicon member 220 according to another embodiment.

The silicon member 220 includes a groove 221. In the present embodiment, the groove 221 is formed by deep reactive ion etching (DRIE) that is a kind of dry etching.

As illustrated in FIGS. 10 and 11, the silicon member 220 is formed using an SOI wafer 224. The SOI wafer 224 includes a first silicon layer 224a, a second silicon layer 224c, and a silicon oxide layer 224b formed between the first silicon layer 224a and the second silicon layer 224c.

The SOI wafer 224 is etched by a DRIE process. The DRIE process can form a more vertical etching surface than the wet etching process using KOH. Therefore, the discharge space 250 can be formed larger than the discharge space 140 (See FIG. 2).

Also, since the silicon member 220 is formed by etching the SOI wafer 224, the etching depth can be easily adjusted. That is, the silicon oxide layer 224b functions to prevent the second silicon layer 224c from being etched during the DRIE process.

Accordingly, the silicon member 220 includes the first silicon layer 220a with the shape of a quadrangle tube, the silicon oxide layer 220b with the shape of the quadrangle tube, and the second silicon layer 220c with the shape of a plate. Consequently, the silicon member 220 has the shape with the groove 221.

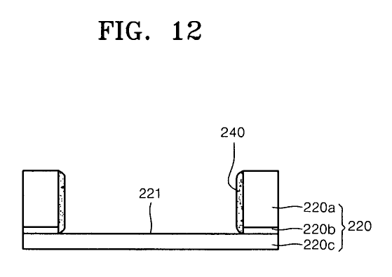

Thereafter, as illustrated in FIG. 12, a phosphor is coated on inner surfaces of the first silicon layer 220a and the silicon oxide layer 220b, thereby forming the phosphor layer 240.

Thereafter, the silicon member 220 is attached to the substrate 210. The silicon member 220 is joined to the substrate 210 in a chamber containing discharge gas of a given pressure. At this point, the silicon member 220 is attached to the substrate 210 by anodic bonding.

An operation of the gas discharge display device 200 will now be described.

When an AC discharge voltage is applied from an external power source to the second silicon layer 220c and the discharge electrode 230, a current flows though the second silicon layer 220c and a discharge occurs between the second silicon layer 220c and the discharge electrode 230.

In this manner, when a suitable discharge occurs between the second silicon layer 220c and the discharge electrode 230, the discharge gas is excited. At this point, the energy level of the excided discharge gas is lowered to emit visible light and a large amount of ultraviolet light.

The emitted ultraviolet light excites the phosphor of the phosphor layer 240. The energy level of the excited phosphor is lowered to emit visible light.

This emitted light is outputted through the substrate 210, thereby creating an image perceivable by users.

As above, the gas discharge display device 200 is simple in structure and can be easily fabricated using a minute silicon process. Therefore, the gas discharge device 200 can be miniaturized and thus a minute discharge cell can be implemented. Accordingly, when the discharge cells are arranged in a tile fashion, it is possible to implement the gas discharge display device with high resolution.

Also, since the silicon member 220 is formed using monocrystalline silicon, the driving circuit can be directly formed on the silicon member 220, thereby reducing the required space and cost.

Also, since the silicon member 220 is formed using the SOI wafer 224, the etching depth for the groove 221 can be easily adjusted to implement the precise structure. Therefore, it is possible to reduce the defective percentage and the fabrication speed.

As described above, the gas discharge display device is simple in structure and can be easily fabricated using a minute silicon process. Therefore, the gas discharge device can be miniaturized and thus the minute discharge cell can be implemented. Accordingly, when the discharge cell is arranged in a tile fashion, it is possible to implement the gas discharge display device with high resolution.

Also, since the silicon member is formed using monocrystalline silicon, the driving circuit can be directly formed on the silicon member. Accordingly, it is possible to reduce the required space and cost.

Also, the silicon member can be formed using the SOI wafer. In this case, the etching depth for the groove 221 can be easily adjusted to implement the precise structure. Therefore, it is possible to reduce the defective percentage and the fabrication speed.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A gas discharge display device comprising:
a substrate;
a silicon member attached to the substrate, the silicon member having a groove formed on at least a portion of its inner surface configured to form a discharge space in cooperation with the substrate;
a discharge electrode disposed on the substrate; and
discharge gas disposed in the discharge space.

2. The gas discharge display device of claim 1, wherein the substrate includes glass.

3. The gas discharge display device of claim 1, wherein the silicon member is attached to the substrate by anodic bonding.

4. The gas discharge display device of claim 1, wherein the silicon member includes monocrystalline silicon.

5. The gas discharge display device of claim 1, wherein the silicon member is formed using an SOI (silicon on insulator) wafer.

6. The gas discharge display device of claim 5, wherein the SOI wafer includes at least two silicon layers and a silicon oxide (SiO₂) layer formed between the silicon layers.

7. The gas discharge display device of claim 1, wherein the groove is formed by an etching process using potassium hydroxide.

8. The gas discharge display device of claim 1, wherein the groove is formed by a deep reactive ion etching process.

9. The gas discharge display device of claim 1, wherein the discharge electrode includes an indium tin oxide.

10. The gas discharge display device of claim 1, wherein one of the silicon member and the discharge electrode functions as a cathode electrode and the other functions as an anode electrode.

11. The gas discharge display device of claim 1, wherein the discharge gas includes neon (Ne).

12. The gas discharge display device of claim 1, wherein the discharge gas includes xenon (Xe).

13. The gas discharge display device of claim 1, comprising one of the discharge electrode formed to such a length to contact another portion of the inner surface of the silicon member where the groove is not formed; and further comprising an insulating layer formed on at least a part of the another portion to electrically insulate the discharge electrode from the silicon member.

14. The gas discharge display device of claim 13, wherein the insulating layer includes a silicon oxide (SiO₂).

15. The gas discharge display device of claim 1, further comprising a phosphor layer disposed in the discharge space.

16. The gas discharge display device of claim 15, wherein the phosphor layer includes one selected from the group consisting of a photoluminescent phosphor, a cathodoluminescent phosphor, and a quantum dot.

17. A method of fabricating a gas discharge display device, the method comprising:
forming a discharge electrode on an inner surface of a substrate;
forming a groove on an inner surface of a silicon wafer to form a silicon member; and
joining the substrate and the silicon member by an anodic bonding process to form a discharge space.

18. The method of claim 17, wherein the silicon wafer is an SOI wafer.

19. The method of claim 17, wherein the groove is formed by an etching process using potassium hydroxide.

20. The method of claim 17, wherein the groove is formed by a deep reactive ion etching process.

21. The method of claim 17, wherein the anodic bonding process is performed in a place containing discharge gas.

22. The method of claim 17, wherein the anodic bonding process is performed in an atmospheric environment.

23. The method of claim 22, further comprising the steps of:
discharging air from the discharge space and;
hermetically filling the discharge space with discharge gas.

24. The method of claim 17, further comprising forming a phosphor layer in the discharge space.

25. The method of claim 17, further comprising, forming an insulating layer on at least a part of a portion of the inner surface of the silicon member where the groove is not formed.

26. The method of claim 25, wherein the insulating layer includes a silicon oxide (SiO₂).
